(19) United States
(12) Patent Application Publication
(10) Pub. No.: US 2022/0043898 A1
(43) Pub. Date: Feb. 10, 2022

(54) METHODS AND APPARATUSES FOR ACQUIRING INFORMATION

(71) Applicant: Shanghai Lianshang Network Technology Co., Ltd., Shanghai (CN)

(72) Inventor: Yinglin Cui, Shanghai (CN)

(21) Appl. No.: 17/452,168

(22) Filed: Oct. 25, 2021

Related U.S. Application Data
(63) Continuation of application No. PCT/CN2020/085801, filed on Apr. 21, 2020.

(30) Foreign Application Priority Data
Apr. 25, 2019 (CN) 201910339044.X

(51) Int. Cl. G06F 21/41; G06F 21/51; G06F 21/52

(52) U.S. Cl. CPC G06F 21/41; G06F 21/52; G06F 21/51

(57) ABSTRACT

A method and an apparatus for acquiring information. The method comprises: determining authorization status of an applet on a first applet running platform integrated into a first host application in response to detecting a launch operation on the applet (201); and if the authorization status of the applet is determined as being authorized by a user, executing authorized operation instructions corresponding to the authorization status of being authorized by the user in response to receiving, by the applet on the first applet running platform, the authorized operation instructions (202).

### CROSS REFERENCE TO THE RELATED APPLICATION

This application is the continuation application of International Application No. PCT/CN2020/085801, filed on Apr. 21, 2020, which is based upon and claims priority to Chinese Patent Application No. 201910339044.X, filed on Apr. 25, 2019, the entire contents of which are incorporated herein by reference.

### TECHNICAL FIELD

Embodiments of the present application relate to computer technology, specifically relate to internet technology, and more specifically relate to methods and apparatuses for acquiring information.

### BACKGROUND

When a user uses applets on a terminal device, the user is usually required to authorize the applets to acquire user information or authorize the applets with other contents for applet running platforms in different host applications. The applet herein may be, for example, an applet developed in Java.

In this way, even if the user is using identical applet running platforms, the user is required to perform authorization repeatedly because the host applications are different.

### SUMMARY

Embodiments of the present application present methods and apparatuses for acquiring information.

In a first aspect, an embodiment of the present application provides a method, implemented at a terminal device, for acquiring information. The method comprises: determining authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by the user; and determining the authorization status of the applet as being authorized by a user, executing authorized operation instructions corresponding to the authorization status of being authorized by the user in response to receiving, by the applet on the first applet running platform, the authorized operation instructions.

In a second aspect, an embodiment of the present application provides an apparatus, implemented at a terminal device, for acquiring information. The apparatus comprises: a determination unit configured to: determine authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by the user; and an execution unit configured to: if the authorization status of the applet is determined as being authorized by a user, execute authorized operation instructions corresponding to the authorization status of being authorized by the user in response to receiving, by the applet on the first applet running platform, the authorized operation instructions.

In a third aspect, an embodiment of the present application provides an electronic device. The electronic device comprise: one or more processors; and storage means for storing one or more programs, the one or more programs, when executed by the one or more processors, causing the one or more processors to implement the method as recited in any embodiment of the methods for acquiring information.

In a fourth aspect, an embodiment of the present application provides a computer readable storage medium storing computer programs thereon, the computer programs, when executed by a processor, implementing the method as recited in any embodiment of the methods for acquiring information.

The solution for acquiring information provided in the embodiments of the present application determines authorization status of an applet on a first applet running platform integrated into a first host application in response to detecting a launch operation on the applet at first, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by the user. Then, if the authorization status of the applet is determined as being authorized by a user, authorized operation instructions corresponding to the authorization status of being authorized by the user are executed in response to receiving, by the applet on the first applet running platform, the authorized operation instructions. In the solution provided in the embodiments of the present application, the user launches some applet in a host application. If the user has already authorized the applet in other host applications on the terminal device, there is no need to prompt the user for authorization. Further, in the case where the applet exists in more than two host applications on the terminal device, the authorization status of the applet may be shared among various host applications installed on the terminal device. In this way, the user may be prevented from being repeatedly prompted for authorization after the user has authorized the applet, and efficiency for launching the applet can be improved.

### DESCRIPTIONS OF THE DRAWINGS

Other features, objects, and advantages of the present application will become more apparent by reading the detailed description of non-limiting embodiments with reference to the following drawings:

FIG. 1 is an exemplary system architecture diagram in which the present application may be applied;

FIG. 2 is a flowchart of an embodiment of a method for acquiring information according to the present application;

FIG. 3 is a schematic diagram of an application scenario for a method for acquiring information according to the present application;

FIG. 4 is a flowchart of another embodiment of a method for acquiring information according to the present application;

FIG. 5 is a schematic structural diagram of an embodiment of an apparatus for acquiring information according to the present application; and

FIG. 6 is a schematic structural diagram of a computer system suitable for implementing an electronic device of the embodiments of the present application.

### DETAILED EMBODIMENTS

The following describes the present application in detail with reference to the accompanying drawings and embodiments. It can be understood that the specific embodiments described herein are only used to explain the related disclosure, but not to limit the disclosure. It should also be noted that, for convenience of description, only the parts related to the related disclosure are shown in the drawings.

It should be noted that, in the case of no conflict, the embodiments in the present application and the features in the embodiments can be combined with each other. The application will be described in detail below with reference to the drawings and embodiments.

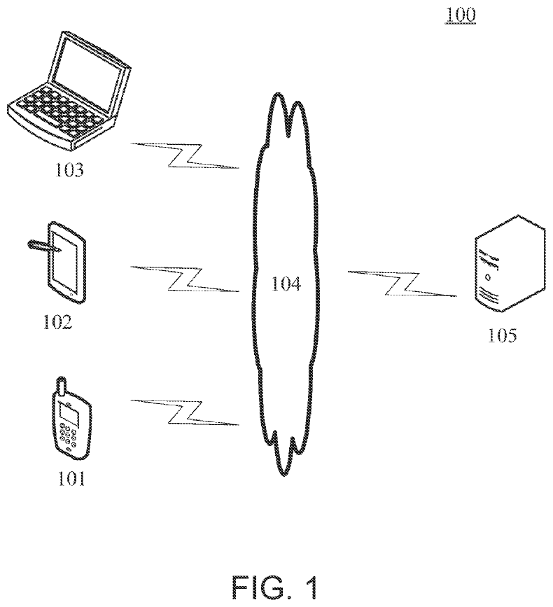

FIG. 1 shows an exemplary system architecture 100 in which an embodiment of a method for acquiring information or an apparatus for acquiring information in which the present application may be implemented.

As shown in FIG. 1, the system architecture 100 may comprise terminal devices 101, 102, 103, network 104, and a server 105. The network 104 is a medium for providing a communication link between the terminal devices 101, 102, 103 and the server 105. The network 104 may comprise various connection types, such as wired or wireless communication links, or fiber optic cables, among others.

The user can use the terminal devices 101, 102, 103 to interact with the server 105 through the network 104 to receive or send messages and the like. Various host applications of communication client may be installed on the terminal devices 101, 102, 103, such as video type host applications, live streaming type host applications, instant messaging tools, email clients, social platform software, etc.

The terminal devices 101, 102, 103 herein may be hardware, or may be software. When implemented in hardware, the terminal devices 101, 102, 103 may be various electronic devices with a display, including but not limited to, smart phones, tablets, e-book readers, laptop portable computers and desktop computers, etc. When implemented in software, the terminal devices 101, 102, 103 may be installed in the electronic devices listed above. The terminal devices 101, 102, 103 may be implemented as a plurality of software or software modules (for example, a plurality of software or software modules for providing distributed services), or as a single software or software module. No specific limitation is made herein.

The server 105 may be a server that provides various services, such as a background server that provides support for the terminal devices 101, 102, 103. The background server may process (such as analyze) the received data such as an authorization status query request, and feedback the processing result (such as the authorization status) to the terminal devices.

It should be noted that the method for acquiring information provided in the embodiments of the present application is generally executed by the terminal devices 101, 102, 103. Accordingly, the apparatus for acquiring information is generally provided in the terminal devices 101, 102, 103.

It should be understood that the numbers of the terminal devices, networks, and servers in FIG. 1 are merely exemplary. Depending on the implementation needs, there can be any number of terminal devices, networks, and servers.

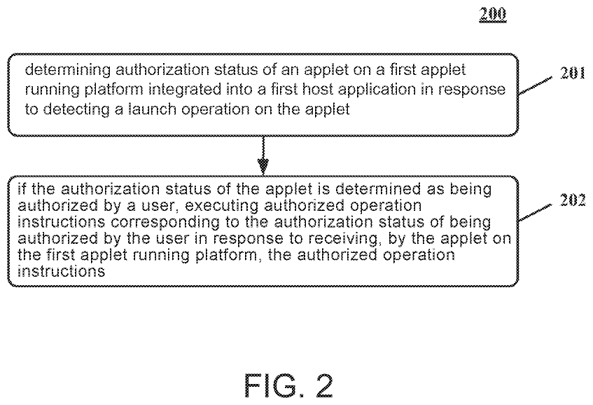

Continued reference is made to FIG. 2, which shows a flow 200 of an embodiment of a method for acquiring information according to the present application. The method for acquiring information comprises the following steps.

At step 201, authorization status of an applet on a first applet running platform integrated into a first host application is determined in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by a user.

In this embodiment, the entity (e.g., the terminal devices as shown in FIG. 1) performing the method for acquiring information may be installed with at least one host application. For example, the at least one host application may comprise a first host application and at least a second host application. The above entity may determine authorization status of an applet on a first applet running platform integrated into the above first host application in response to detecting a launch operation on the applet. The first applet running platform and the second applet running platform herein may be identical applet running platforms, i.e. applet running platforms with the same identification. In addition, the first applet running platform and the second applet running platform may also be different applet running platforms. The launch operation is a user operation for launching the above applet. The above applet may run on the above first applet running platform and the second applet running platform. The authorization status of the applet herein may refer to the authorization status common to the above applets on the first applet running platform and the second applet running platform integrated into any one of the host applications installed on the above terminal device.

The first host application may be any one of the host applications installed on the terminal device and integrated with the above first applet running platform. The second host application may be any one of the host applications installed on the terminal device and integrated with the above second applet running platform. Specifically, the applet running platform is used to provide a running environment for the applet in the host application, which is a necessary condition for the applet to be launched and run in the host application. The applet running platform may provide the applet with a template of the interface to be displayed, a browser, and personalized services for different host applications or different operating systems. Any one of the host applications installed on the terminal device may be integrated with multiple different applet running platforms. The host application refers to an application which is integrated with an applet running platform. It should be noted that the “first” and “second” herein do not represent ordering.

All of the one or more host applications installed on the above terminal devices may integrated with the above first applet running platform. The authorization status indicates whether the user has authorized the above applet on the applet running platform to execute certain operation instructions, to enable the above entity to perform operations corresponding to the above operation instructions in the above applet.

In practice, the authorization status of the applet on the above second applet running platform may be determined by the above entity and stored in the above entity. In addition, the authorization status of the applet on the above second applet running platform may also be determined by other electronic devices such as the server, and stored in the other electronic devices such as the server. The above entity may acquire the authorization status of the applet from the other electronic devices such as the server.

The above entity may determine the authorization status of the applet on the second applet running platform as the authorization status of the applet directly, or may modify the authorization status of the applet on the second applet running platform. For example, the modification may comprise determining an opposite authorization status (e.g., the authorization status of being authorized by the user is mutually opposite to the authorization status of being unauthorized by the user), and use the modification result as the authorization status of the applet.

At step 202, if the authorization status of the applet is determined as being authorized by a user, authorized operation instructions corresponding to the authorization status of being authorized by the user are executed in response to receiving, by the applet on the first applet running platform, the authorized operation instructions.

In this embodiment, in response to determining the authorization status of the applet as being authorized by the user, the above entity may not need to prompt the user to authorize the applet. If authorized operation instructions are received, the above entity may directly execute the authorized operation instructions in the above applet running on the above applet running platform in the first host application.

Specifically, the authorized operation instructions refer to operation instructions authorized by the user from the above mentioned authorization status of being authorized by the user, i.e., corresponding to the authorization status of being authorized by the user. The authorized operation instructions indicate the operation instructions already authorized by the user. After the above applet is authorized, the above entity may execute the authorized operation instructions in the above applet. The authorized operation instructions may be various operations performed by the terminal device in the above applet. For example, the terminal device acquires a user's web browsing history in the above applet and uploads the history to a server corresponding to the above applet.

In some implementations of this embodiment, the authorized operation instructions indicate at least one of the operations performed in the applet: acquiring user's personal information, acquiring location information of the terminal device, and invoking a camera.

In these implementations, the user's personal information may be user's property information, such as gender, age, etc. In addition, the user's personal information may also be historical data for the user, such as web browsing history, user operation history, etc. The location information of the terminal device may comprise latitude and longitude coordinates, and may also comprise names of geographical areas, such as road A. The location information of the terminal device may be the current location information of the terminal device, or may also be the location information or a set of location information of the terminal device within a preset time period in the past such as a set of location information of the terminal device in the past month.

In some implementations of this embodiment, the first applet running platform and the second applet running platform are identical applet running platforms; or the first applet running platform and the second applet running platform are applet running platforms of the same type. Applet running platforms of the same type use the same applet platform framework and/or applet platform encoding specification.

In these implementations, the above first applet running platform and the above second applet running platform may be identical applet running platforms with the same identification, or applet running platforms of the same type with different identifications. If at least two applet running platforms are identical or of the same type, then multiple applets may run on these two applet running platforms. For example, in this embodiment, multiple applets may not only run on the above first applet running platform but also run on the above second applet running platform.

Identical applets may often be installed on identical applet running platforms or applet running platforms of the same type, while the applets installed on different applet running platforms or applet running platforms of different types are usually different to a large extent. In the case where the applet running platforms on which the applets are running are identical applet running platforms or applet running platforms of the same type, the identical applets may be targeted to prevent repeated request for authorization for these applets on the applet running platforms integrated into various host applications through the above implementations.

In some application scenarios of these implementations, after the above step 201, the method further comprises:

if the authorization status of the applet is determined as being unauthorized by a user, displaying an authorization request on the applet on the first applet operating platform; in response to detecting a user authorization operation, modifying the authorization status of the applet into being authorized by the user on the first applet running platform and an applet running platform of the same type as the first applet running platform.

In these application scenarios, the above entity may display the authorization request to prompt the user for authorization in response to determining the authorization status of the above applet as being unauthorized by the user. If a user authorization operation is detected, the above entity may modify the authorization status into being authorized by the user on the first applet running platform and an applet running platform of the same type as the first applet running platform. The above entity may execute the authorized operation instructions corresponding to the authorization status of being authorized by the user in response to receiving, by the above applet, the authorized operation instructions. The applet herein may be an applet on the first applet running platform or an applet running platform of the same type as the first applet running platform integrated into any host application installed on the above terminal device.

The authorization request is the information displayed to the user by the above entity for requesting authorization from the user. The user authorization operation is a user operation for indicating that the user has made authorization.

In these application scenarios, the user may be automatically prompted for authorization in case of the authorization status of being unauthorized by the user. After the user's authorization is confirmed, the above entity may then execute the authorized operation instructions in the above applet.

In some application scenarios of these implementations, determining the authorization status of the applet at step 201 comprises: determining the authorization status of the applet on the first applet running platform and/or an applet running platform of the same type as the first applet running platform.

In these application scenarios, in the case where the first applet running platform and the second applet running platform are identical applet running platforms, the above entity may determine running status of the applet on the first applet running platform, and may further determine running status of the applet on the first applet running platform and an applet running platform of the same type as the first applet running platform. In the case where the first applet running platform and the second applet running platform are different applet running platforms but are of the same type, the above entity may determine authorization status of the applet on an applet running platform of the same type as the first applet running platform.

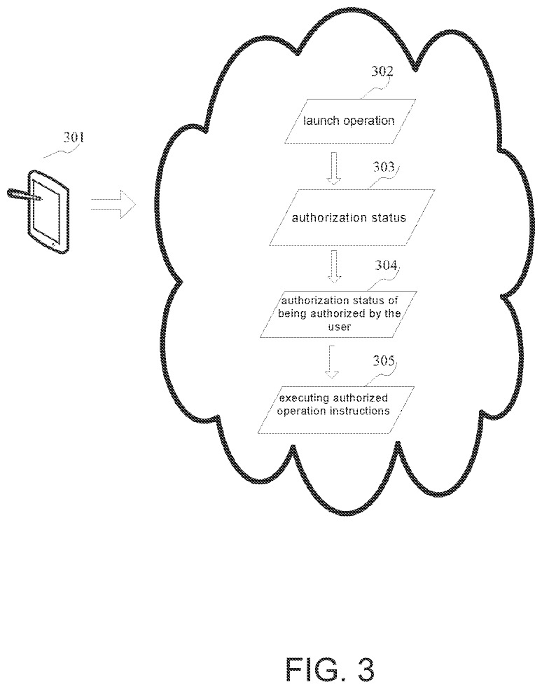

With continued reference to FIG. 3, FIG. 3 is a schematic diagram of an application scenario of a method for acquiring information according to the present embodiment. In the application scenario of FIG. 3, Tom performs a launch operation 302 on a game applet of instant messaging host application W on his phone 301. The game applet generates an instruction which instructs to acquire location information of phone 301. The phone 301 may determine the authorization status 303 of the game applet based on the authorization status of that game applet of another host application H on the phone. If the authorization status 303 is determined as being authorized by the user 304, the phone 301 may acquire and use the location information of the phone 301 in the game applet of the instant messaging host application W, i.e., executing authorized operation instruction 305.

In the method provided in the above embodiments of the present application, the user launches an applet in a host application. If the user has already authorized the applet in other host applications on the terminal device, there is no need to prompt the user for authorization. Further, in the case where an applet exists in more than two host applications on the terminal device, the authorization status of the applet may be shared among various host applications installed on the terminal device. In this way, the user may be prevented from being repeatedly prompted for authorization after the user has authorized the applet, and efficiency for launching the applet can be improved.

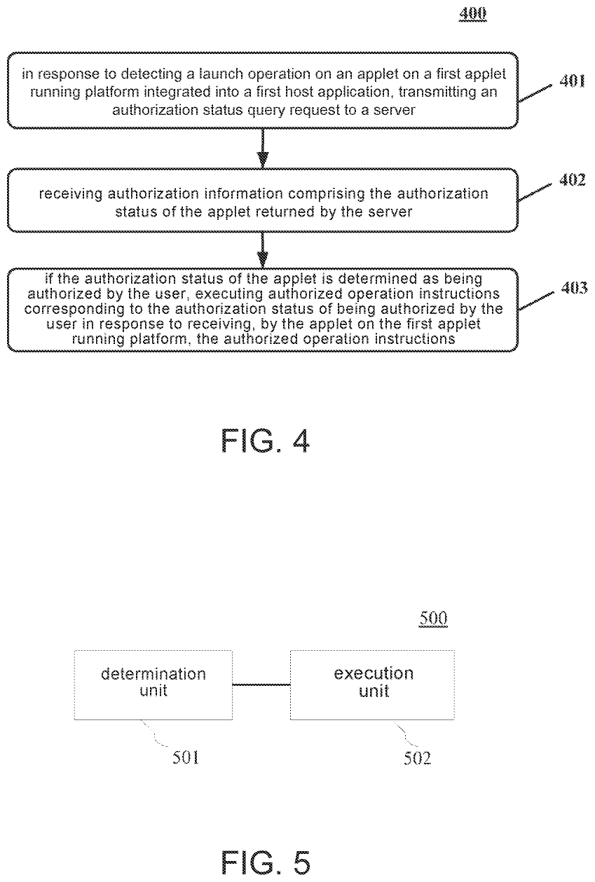

Further reference is made to FIG. 4, which shows a flowchart 400 of another embodiment of a method for acquiring information. The flowchart 400 of the method for acquiring information comprises the following steps.

At step 401, in response to detecting a launch operation on an applet on a first applet running platform integrated into a first host application, an authorization status query request is transmitted to a server, wherein the authorization status query request comprises an identification on the applet.

In this embodiment, the entity (e.g., the terminal device as shown in FIG. 1) performing the method for acquiring information may transmit the authorization status query request to the server, to acquire authorization status returned by the server. Specifically, the server may provide authorization-related services and store authorization status of applets. The authorization status query request is the information used to request the server to return authorization status. The above entity may transmit the authorization status query request along with the identification of the above applet. As such, the server may retrieve the authorization status of the applet corresponding to the identification, and in turn return the authorization status to the above entity.

At step 402, authorization information comprising the authorization status of the above applet returned by the server is received.

In this embodiment, the above entity may receive the returned authorization information comprising the authorization status of the above applet after the server returns the authorization status of the above applet. Specifically, the authorization information may refer to information related to authorization.

At step 403, if the authorization status of the applet is determined as being authorized by a user, authorized operation instructions corresponding to the authorization status of being authorized by the user are executed in response to receiving, by the applet on the first applet running platform, the authorized operation instructions.

In this embodiment, in response to determining the authorization status of the applet as being authorized by the user, the above entity may not need to prompt the user to authorize the applet. If authorized operation instructions are received, the above entity may directly execute the authorized operation instructions in the above applet running on the above applet running platform in the first host application.

In some application scenarios of these implementations, the above method further comprises: in response to detecting a user modification operation indicative of modifying the authorization status of the applet, re-determining the authorization status of the applet based on the user modification operation; and synchronizing the re-determined authorization status to the server.

In these application scenarios, the above entity may modify, in response to detecting the user modification operation, the authorization state of the applet into an authorization state indicated by the above user modification operation. For example, the authorization status may be generated by the user selecting “authorize” and “not authorize” displayed on an interface. Afterwards, the above entity may upload the re-determined authorization status to the server for synchronization.

These implementations allow the user to freely modify the authorization status, to ensure flexible control over the authorization status by the user. To some extent, the applet may be prevented from using user information on the terminal device against the user's will or enabling some functions of the terminal device without the user knowing it.

In some cases of these application scenarios, synchronizing the re-determined authorization status to the server as mentioned above comprises: synchronizing the re-determined authorization status to the server in response to determining the authorization status of the applet is changed.

In these cases, the above entity may determine whether the authorization status is changed based on the prior authorization status determined last time and the re-determined authorization status. The above entity may synchronize the authorization state to the server when determining that the authorization state is changed.

In these cases, it may be determined whether the authorization status is changed at first. If so, then the authorization status is synchronized to the server, thereby preventing ineffective synchronization.

In some application scenarios of these implementations, before the step 401, the method further comprises: in response to detecting, by the second host application, a user authorization operation on the applet on the second applet running platform, synchronizing the authorization status of being authorized by the user in correspondence with a host application identification on the second host application to the server.

In these application scenarios, the above entity may associate the authorization status with the host application identification on the second host application, and synchronize such information to the server. In this way, a variety of information associated with the authorization of the above applet running platform may be stored on the server. The host application identification on the second host application is synchronized to the server as the host application identification of the host application in which the above applet running platform is hosted. In addition, the above entity may also synchronize an identification on the above terminal device to the server. A list of authorized permissions may also be stored on the server.

In some implementations of the present application, the authorization status query request further comprises the identification on the terminal device; and receiving the authorization information comprising the authorization status of the applet returned by the server comprises:

receiving authorization information on the applet for the terminal device returned by the server, wherein authorization status for different terminal devices is independent from each other.

In these implementations, the authorization status in the authorization information of the above applet returned by the above server may be specific to the above terminal device. Authorization status of an applet corresponding to a terminal device would not affect the authorization status of the applet corresponding to another terminal device, so the authorization status is specific to the above terminal device and is not related to other terminal devices.

A server is utilized to store the authorization status and the authorization status may be queried from the server in the present embodiment. The server is a long-term storage medium with larger storage space, which may prevent data loss of authorization status, and may be more beneficial to the storage of authorization status.

With further reference to FIG. 5, as an implementation of the methods shown in the foregoing figures, the present application provides an embodiment of an apparatus for acquiring information. This apparatus embodiment corresponds to the method embodiment shown in FIG. 2, and the apparatus can be specifically implemented at various electronic devices.

As shown in FIG. 5, the apparatus 500 for acquiring information in the present embodiment comprises: a determination unit 501 and an execution unit 502. The determination unit 501 is configured to: determine authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by the user. The execution unit 502 is configured to: if the authorization status of the applet is determined as being authorized by the user, authorized operation instructions corresponding to the authorization status of being authorized by the user are executed in response to receiving, by the applet on the first applet running platform, the authorized operation instructions.

In some embodiments, at least one host application may be installed on the determination unit 501 of the apparatus 500 for acquiring information. For example, the at least one host application may comprise a first host application and at least a second host application. The above entity may determine authorization status of the applet on a first applet running platform integrated into the above first host application in response to detecting a launch operation on the applet. The first applet running platform and the second applet running platform herein may be identical applet running platforms, i.e. applet running platforms with the same identification. In addition, the first applet running platform and the second applet running platform may also be different applet running platforms. The launch operation is a user operation for launching the above applet.

In some embodiments, the execution unit 502 may be responsive to the determination of the authorization status of the applet as being authorized by a user, and the above entity may not need to prompt the user for authorization. If authorized operation instructions are received, the above entity may directly execute the authorized operation instructions in the above applet running on the above applet running platform in the first host application.

In some implementations of this embodiment, the first applet running platform and the second applet running platform are identical applet running platforms; or the first applet running platform and the second applet running platform are applet running platforms of the same type. Applet running platforms of the same type use the same applet platform framework and/or applet platform encoding specification.

In some implementations of this embodiment, after determining the authorization status of the applet, the apparatus further comprises: a display unit configured to display an authorization request on the applet on the first applet running platform if the authorization status of the applet is determined as being unauthorized by the user; a detection unit configured to modify, in response to detecting a user authorization operation, the authorization status of the applet into being authorized by the user on the first applet running platform and an applet running platform of the same type as the first applet running platform.

In some implementations of this embodiment, the determination unit comprises a determination module configured to determine the authorization status of the applet on the first applet running platform and/or an applet running platform of the same type as the first applet running platform.

In some implementations of this embodiment, the determination unit comprises: a transmission module configured to transmit an authorization status query request to a server, wherein the authorization status query request comprises an identification on the applet; and a reception module configured to receive authorization information comprising the authorization status of the applet returned by the server.

In some implementations of this embodiment, the method further comprises: a re-determination unit configured to re-determine, in response to detecting a user modification operation indicative of modifying the authorization status of the applet, the authorization status of the applet based on the user modification operation; and a first synchronization unit configured to synchronize the re-determined authorization status to the server.

In some implementations of this embodiment, the synchronization unit is further configured to: synchronize, in response to determining that the authorization status of the applet is changed, the re-determined authorization status to the server.

In some implementations of this embodiment, before determining the authorization status of the applet on the first applet running platform integrated into the first host application in response to detecting the launch operation on the applet, the apparatus further comprises: a second synchronization unit configured to synchronize, in response to detecting, by the second host application, a user authorization operation on the applet on the second applet running platform, the authorization status of being authorized by the user in correspondence with a host application identification on the second host application to the server.

In some implementations of this embodiment, the authorization status query request further comprises an identification on the terminal device; and the reception module is further configured to: receive authorization information on the above applet for the identification on the terminal device returned by the server, wherein authorization status for different terminal devices is independent from each other.

In some implementations of this embodiment, the authorized operation instructions indicate at least one of the operations performed in the applet: acquiring user's personal information, acquiring location information of the terminal device, and invoking a camera.

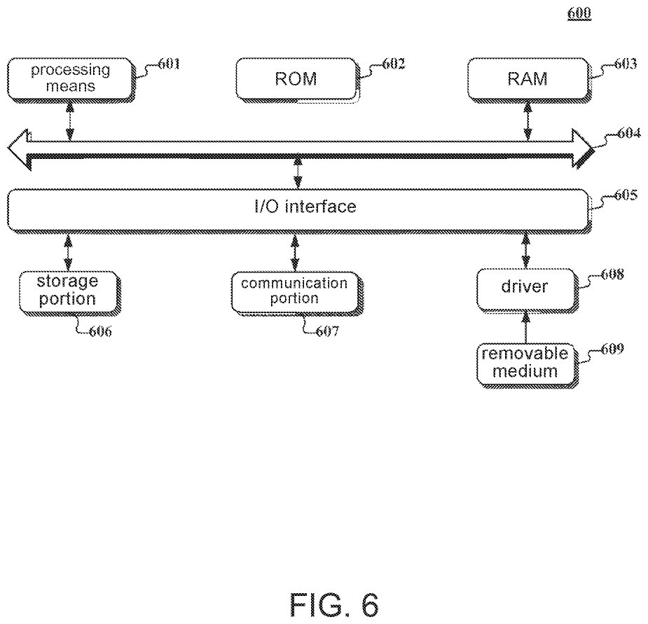

As shown in FIG. 6, an electronic device 600 may include a processing means (such as a central processing unit, a graphic processing unit) 601, which can perform various appropriate actions and processing according to the programs stored in a read-only memory (ROM) 602 or programs loaded from storage means 608 into a random access memory (RAM) 603. In the RAM 603, various programs and data necessary for the operations of the electronic device 600 are also stored. The processing means 601, ROM 602, and RAM 603 are connected to each other via a bus 604. An input/output (I/O) interface 605 is also connected to the bus 604.

Generally, the following means may be connected to the I/O interface 605: an input means 606 including for example a touch screen, a touch panel, a keyboard, a mouse, a camera, a microphone, an accelerometer and a gyroscope etc.; an output means 607 including for example a Liquid Crystal Display (LCD), a speaker and a vibrator etc.; the storage means 608; and a communication means 609. The communication means 609 may permit the electronic device 600 to conduct wireless or wired communication with other devices to exchange data. While FIG. 6 shows an electronic device 600 with various means, it should be understood that it is not required to implement or possess all the means shown. More or fewer means may be implemented or provided instead. Each block shown in FIG. 6 may represent one means, or may represent multiple means as needed.

In particular, according to the embodiments of the present disclosure, the processes described above with reference to the flowcharts may be implemented as computer software programs. For example, embodiments of the present disclosure include a computer program product including a computer program carried on a computer-readable medium, the computer program containing program code for performing a method shown in a flowchart. In such embodiments, the computer program may be download and installed from a network though the communication means 609, or installed from the storage means 608, or installed from the ROM 602. The computer program, when executed by the processing means 601, executes the above functions defined in the method of the embodiments of the present disclosure. It should be noted that the computer readable medium in the embodiments of the present disclosure may be a computer readable signal medium or a computer readable storage medium or any combination of the above two. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: electrical connections with one or more wires, portable computer magnetic disks, hard disks, random access memory (RAM), read-only memory (ROM), erasable Programming read-only memory (EPROM or flash memory), optical fiber, portable compact disk read-only memory (CD-ROM), optical storage device, magnetic storage device, or any suitable combination of the foregoing. In the embodiments of the present disclosure, a computer readable storage medium may be any tangible medium that contains or stores a program that can be used by or in combination with an instruction execution system, apparatus, or device. In the embodiments of the present disclosure, a computer-readable signal medium may include a data signal that is included in a baseband or propagated as part of a carrier wave, and which carries computer-readable program code. Such a propagated data signal may take many forms, including but not limited to electromagnetic signals, optical signals, or any suitable combination of the foregoing. A computer-readable signal medium may also be any computer-readable medium other than a computer-readable storage medium, and the computer-readable signal medium may send, propagate, or transmit a program for use by or in connection with an instruction execution system, apparatus, or device. Program code embodied on a computer-readable medium may be transmitted using any appropriate medium, including but not limited to: wired, optical fiber cable, radio frequency (RF) etc., or any suitable combination of the foregoing.

The flowchart and block diagrams in the accompanying drawings illustrate the architecture, functionality, and operation of possible implementations of systems, methods and computer program products according to various embodiments of the present application. In this regard, each block in the flowchart or block diagram may represent a module, a program segment, or a part of code, a portion of which contains one or more executable instructions for implementing a specified logical function. It should also be noted that in some alternative implementations, the functions labeled in the blocks may also occur in a different order than those labeled in the drawings. For example, two successively represented blocks may actually be executed substantially in parallel, and they may sometimes be executed in a reverse order, depending on the functions involved. It should also be noted that each block in the block diagrams and/or flowcharts, and combinations of blocks in the block diagrams and/or flowcharts, can be implemented by a dedicated hardware-based system that performs the specified function or operation, or it can be implemented with a combination of dedicated hardware and computer instructions.

The units described in the embodiments of the present application may be implemented by software or hardware. The described unit may also be provided in a processor, for example, it may be described as: a processor including a determination unit and an execution unit. The names of these units do not constitute a limitation on the units per se in some cases. For example, the execution unit may also be described as a unit for determining authorization status of an applet on a first applet running platform integrated into a first host application in response to detecting a launch operation on the applet.

As another aspect, the present application further provides a computer-readable medium, which may be included in the apparatus described in the foregoing embodiments; or may exist alone without being assembled into the apparatus. The computer-readable medium carries one or more programs. When the one or more programs are executed by the apparatus, the apparatus is caused to: determine authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by the user; and if the authorization status of the applet is determined as being authorized by the user, execute authorized operation instructions corresponding to the authorization status of being authorized by the user in response to receiving, by the applet on the first applet running platform, the authorized operation instructions.

The above description is only a embodiment of the present application and an explanation of the technical principles applied. Those skilled in the art should understand that the scope of the disclosure involved in the present application is not limited to the technical solution composed of a specific combination of the above-mentioned technical features, but should also cover other technical solutions formed by any arbitrary combination of the above-mentioned technical features or their equivalents without departing from the above inventive concept. For example, a technical solution formed by replacing the technical features disclosed (but not limited to) in the present application with technical features having similar functions.

What is claimed is:

1. A method, implemented at a terminal device, for acquiring information, comprising:
determining authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by a user; and
if the authorization status of the applet is determined as being authorized by a user, executing authorized operation instructions corresponding to the authorization status of being authorized by the user in response to receiving, by the applet on the first applet running platform, the authorized operation instructions.

2. The method as recited in claim 1, wherein,
the first applet running platform and the second applet running platform are identical applet running platforms; or
the first applet running platform and the second applet running platform are applet running platforms of the same type, wherein applet running platforms of the same type use the same applet platform framework and/or applet platform encoding specification.

3. The method as recited in claim 2, wherein after determining the authorization status of the applet, the method further comprising:
if the authorization status of the applet is determined as being unauthorized by the user, displaying an authorization request on the applet on the first applet running platform; and
in response to detecting a user authorization operation, modifying the authorization status of the applet into being authorized by the user on the first applet running platform and an applet running platform of the same type as the first applet running platform.

4. The method as recited in claim 2, wherein determining the authorization status of the applet comprising:
determining the authorization status of the applet on the first applet running platform and/or an applet running platform of the same type as the first applet running platform.

5. The method as recited in claim 1, wherein determining the authorization status of the applet comprising:
transmitting an authorization status query request to a server, wherein the authorization status query request comprises an identification on the applet; and
receiving authorization information comprising the authorization status of the applet returned by the server.

6. The method as recited in claim 5, wherein the method further comprising:
in response to detecting a user modification operation indicative of modifying the authorization status of the applet, re-determining the authorization status of the applet based on the user modification operation; and
synchronizing the re-determined authorization status to the server.

7. The method as recited in claim 6, wherein synchronizing the re-determined authorization status to the server comprising:
in response to determining that the authorization status of the applet is changed, synchronizing the re-determined authorization status to the server.

8. The method as recited in claim 5, wherein before determining the authorization status of the applet on the first applet running platform integrated into the first host application in response to detecting the launch operation on the applet, the method further comprising:
in response to detecting, by the second host application, a user authorization operation on the applet on the second applet running platform, synchronizing the authorization status of being authorized by a user in correspondence with a host application identification on the second host application to the server.

9. The method as recited in claim 5, wherein the authorization status query request further comprises an identification on the terminal device; and
wherein receiving the authorization information comprising the authorization status of the applet returned by the server comprising:
receiving authorization information on the applet for the identification on the terminal device returned by the server, wherein authorization status for different terminal devices is independent from each other.

10. An electronic device, comprising:
one or more processors; and
storage means for storing one or more programs,
wherein the one or more programs, when executed by the one or more processors, cause the one or more processors to:
determine authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by a user; and
if the authorization status of the applet is determined as being authorized by a user, execute authorized operation instructions corresponding to the authorization status of being authorized by the user in response to receiving, by the applet on the first applet running platform, the authorized operation instructions.

11. A computer readable storage medium storing computer programs thereon, the computer programs, when executed by a processor, cause the processor to:
determine authorization status of an applet on a first applet running platform integrated into a first host application in response to detecting a launch operation on the applet, wherein at least a second host application installed on the terminal device is integrated with a second applet running platform, and wherein the authorization status of the applet is determined according to the authorization status of the applet on the second applet running platform integrated into the second host application, and wherein the authorization status comprises an authorization status of being authorized by a user and an authorization status of being unauthorized by a user; and
if the authorization status of the applet is determined as being authorized by a user, execute authorized operation instructions corresponding to the authorization status of being authorized by the user in response to receiving, by the applet on the first applet running platform, the authorized operation instructions.
